(19) United States
(12) Patent Application Publication
(10) Pub. No.: US 2024/0148213 A1
(43) Pub. Date: May 9, 2024

(54) ROBOT, ROBOT SYSTEM AND CONTROLLING METHOD THEREOF

(71) Applicant: Samsung Electronics Co., LTD., Suwon-si (KR)

(72) Inventors: Hyomuk KIM, Suwon-si (KR); Aron Baik, Suwon-si (KR)

(73) Assignee: Samsung Electronics Co., LTD., Suwon-si (KR)

(21) Appl. No.: 18/414,059

(22) Filed: Jan. 16, 2024

Related U.S. Application Data
(63) Continuation of application No. PCT/KR22/12758, filed on Aug. 25, 2022.

(30) Foreign Application Priority Data
Oct. 14, 2021 (KR) 10-2021-0136679

(51) Int. Cl. A47L 11/40

(52) U.S. Cl. CPC A47L 11/4063; A47L 11/4008; A47L 11/4011

(57) ABSTRACT

A robot includes: a communication interface; a sensor configured to obtain distance data; a driver configured to control a movement of the robot; a memory storing with map data corresponding to a space in which the robot travels; and a processor configured to: control the sensor to output a sensing signal for sensing a distance with an external robot, obtain position information of the external robot based on a time at which at least one echo signal is received from the external robot, control at least one of the driver or an operation state of the external robot based on the position information, transmit a control signal for controlling the operation state of the external robot through the communication interface, identify, based on an error occurring in communication with the external robot through the communication interface, a pose of the external robot based on a type of the at least one echo signal received from the external robot, identify a target position of the robot based on the pose of the external robot and the stored map data, and control the driver to move to the target position.

### CROSS REFERENCE TO RELATED APPLICATIONS

This application is a continuation of International Application No. PCT/KR2022/012758, filed on Aug. 25, 2022, in the Korean Intellectual Property Receiving Office, which is based on and claims priority to Korean Patent Application No. 10-2021-0136679, filed on Oct. 14, 2021, in the Korean Intellectual Property Office, the disclosures of which are incorporated by reference herein in their entireties.

### BACKGROUND

### 1. Field

The disclosure relates to robots, a robot system and a controlling method thereof, and more particularly, to a first robot that accommodates a second robot and provides service together with the second robot, a robot system including the first robot and the second robot, and a controlling method thereof.

### 2. Description of Related Art

Recently, developments in technology for robots disposed at an indoor space and provide services to users have become more active. Robots may travel the indoor space and provide various services such as, for example, and without limitation, cleaning, guiding, serving, patrolling, emergency situation response, or the like.

However, there has been a problem of not being able to provide satisfactory service to a user with only a single robot because a dead zone in which a robot cannot travel within a map corresponding to the indoor space may be formed due to limitations in form factor of the robot itself and obstacles positioned within a space.

Robots of the related art have been able to reduce the dead zones by the robot and an external robot accommodated in the robot cooperating and providing a service, but there is still a problem of providing smooth service being difficult when an error in communication occurs between the robot and the external robot. Accordingly, there is a continuous need for a method which can actively overcome an error when a communication error between the robot and the external robot occurs.

### SUMMARY

According to an aspect of the disclosure, a robot includes: a communication interface; a sensor configured to obtain distance data; a driver configured to control a movement of the robot; a memory storing with map data corresponding to a space in which the robot travels; and a processor configured to: control the sensor to output a sensing signal for sensing a distance with an external robot, obtain position information of the external robot based on a time at which at least one echo signal is received from the external robot, control at least one of the driver or an operation state of the external robot based on the position information, transmit a control signal for controlling the operation state of the external robot through the communication interface, identify, based on an error occurring in communication with the external robot through the communication interface, a pose of the external robot based on a type of the at least one echo signal received from the external robot, identify a target position of the robot based on the pose of the external robot and the stored map data, and control the driver to move to the target position.

The processor may be further configured to: identify, while communicating with the external robot through the communication interface, the pose of the external robot based on the type of the at least one echo signal received from the external robot, and transmit a control signal for changing the pose of the external robot to the external robot through the communication interface based on the pose of the external robot and the stored map data.

The processor may be further configured to transmit, based on an error occurrence in communication through the communication interface being predicted based on the pose of the external robot and the stored map data, a control signal for changing the pose of the external robot to the external robot through the communication interface.

The processor may be further configured to determine a likelihood of an error occurring in communication through the communication interface based on information on obstacles disposed in an area corresponding to a position of the external robot on the map data, the pose of the external robot, and a moving path of the external robot.

The external robot may include a plurality of sensors configured to output echo signals of different types and disposed at different positions, and the processor may be further configured to: identify, based on an error occurring in communication with the external robot through the communication interface, positions of the plurality of sensors, which output a plurality of echo signals from among the plurality of sensors disposed in the external robot, based on types of the plurality of echo signals received from the external robot, and identify the pose of the external robot based on the positions of the plurality of sensors.

The processor may be further configured to identify, based on pose information being received from the external robot through the communication interface, the target position of the robot based on the pose information, the pose of the external robot, and the stored map data.

The sensor may include a light detection and ranging (LiDAR) sensor, and the processor may be further configured to obtain the position information of the external robot based on a sensing signal obtained by the LiDAR sensor and the time at which the at least one echo signal is received from the external robot.

The sensor may include a light detection and ranging (LiDAR) sensor, and the processor may be further configured to: obtain obstacle information based on a sensing signal obtained by the LiDAR sensor, and change a position of the communication interface based on the obstacle information and the position information of the external robot.

The robot may further include a storage space configured to accommodate the external robot, and the processor may be further configured to: control, based on work by the external robot being identified as necessary, an output of the external robot from the storage space, plan, based on the work by the external robot being identified as completed, a moving path of the external robot based on the pose of the external robot, and control the operation state of the external robot to accommodate the external robot in the storage space based on the moving path.

The communication interface may be configured to communicate according to a short range communication method including Bluetooth communication, and the sensor may include at least one of an infrared sensor or an ultra wide band (UWB) sensor.

According to an aspect of the disclosure, a system includes a first robot and a second robot which is accommodated in a storage space of the first robot, wherein the second robot may include a plurality of sensors configured to output echo signals of different types by being disposed at different positions, and the first robot is configured to: transmit a control signal for outputting the second robot from the storage space to the second robot through a communication interface based on work by the second robot being identified as necessary, transmit, based on the work by the second robot being identified as completed, a control signal for accommodating the second robot in the storage space to the second robot through the communication interface, output a sensing signal for sensing a distance with the second robot, identify, based on an error occurring in communication with the second robot through the communication interface, positions of the respective sensors, which output a plurality of echo signals from among the plurality of sensors disposed in the second robot, based on the types of the plurality of echo signals received from the second robot, identify a pose of the second robot based on the positions of the plurality of sensors, identify a target position of the first robot based on the pose of the second robot and based on map data, and move to the target position.

According to an aspect of the disclosure, a method of controlling a robot, includes: outputting a sensing signal for sensing a distance with an external robot, and obtaining position information of the external robot based on a time at which at least one echo signal is received from the external robot; driving at least one of the robot or the external robot based on the position information; identifying, based on an error in communication with the external robot, a pose of the external robot based on a type of the at least one echo signal received from the external robot; identifying a target position of the robot based on the pose of the external robot and map data; and moving the robot to the target position.

The identifying the pose of the external robot may include identifying, while communicating with the external robot, the pose of the external robot based on the type of at least one echo signal received from the external robot, and the method may further include changing the pose of the external robot based on the pose of the external robot and the map data.

The method may further include changing, based on an error occurrence in communication being predicted based on the pose of the external robot and the map data, the pose of the external robot.

The changing the pose of the external robot may include determining a likelihood of an error occurring in communication based on information of obstacles disposed in an area corresponding to a position of the external robot on the map data, the pose of the external robot, and a moving path of the external robot.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram schematically illustrating a cooperative service providing operation of a robot and an external robot according to an embodiment of the disclosure;

FIG. 2 is a block diagram illustrating a configuration of a robot according to an embodiment of the disclosure;

FIG. 3 is a block diagram illustrating a functional configuration of a robot according to an embodiment of the disclosure;

FIG. 4A and FIG. 4B are diagrams illustrating an operation by a robot identifying a pose of an external robot according to an embodiment of the disclosure;

FIG. 5 is a diagram illustrating an operation by a robot controlling an external robot based on map data according to an embodiment of the disclosure;

FIG. 6 is a diagram illustrating an operation by a robot accommodating an external robot according to an embodiment of the disclosure;

FIG. 7 is a diagram illustrating an error removal operation of a robot according to an embodiment of the disclosure;

FIG. 8 is a diagram illustrating an error removal operation of a robot according to another embodiment of the disclosure;

FIG. 9 is a sequence diagram illustrating a service providing process through a robot system according to an embodiment of the disclosure;

FIG. 10 is a block diagram illustrating in detail a configuration of a robot according to an embodiment of the disclosure; and

FIG. 11 is a flowchart illustrating a controlling method according to an embodiment of the disclosure.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms. It is to be understood that singular forms include plural referents unless the context clearly dictates otherwise. The terms including technical or scientific terms used in the disclosure may have the same meanings as generally understood by those skilled in the art.

Terms used in describing an embodiment of the disclosure are general terms selected that are currently widely used considering their function herein. However, the terms may change depending on intention, legal or technical interpretation, emergence of new technologies, and the like of those skilled in the related art. Further, in certain cases, there may be terms arbitrarily selected, and in this case, the meaning of the term will be disclosed in greater detail in the corresponding description. Accordingly, the terms used herein are not to be understood simply as its designation but based on the meaning of the term and the overall context of the disclosure

In the disclosure, expressions such as “have,” “may have,” “include,” “may include,” or the like are used to designate a presence of a corresponding characteristic (e.g., elements such as numerical value, function, operation, or component), and not to preclude a presence or a possibility of additional characteristics.

Herein, the expression “at least one of A or B” is to be understood as indicating any one of “A” or “B” or “A and B.”

Expressions such as “first,” “second,” “1st,” “2nd,” and so on used herein may be used to refer to various elements regardless of order and/or importance. Further, it should be noted that the expressions are merely used to distinguish an element from another element and not to limit the relevant elements.

When a certain element (e.g., first element) is indicated as being “(operatively or communicatively) coupled with/to” or “connected to” another element (e.g., second element), it may be understood as the certain element being directly coupled with/to the another element or as being coupled through other element (e.g., third element).

A singular expression includes a plural expression, unless otherwise specified. It is to be understood that the terms such as “form” or “include” are used herein to designate a presence of a characteristic, number, step, operation, element, component, or a combination thereof, and not to preclude a presence or a possibility of adding one or more of other characteristics, numbers, steps, operations, elements, components or a combination thereof.

The term “module” or “part” used herein perform at least one function or operation, and may be implemented with a hardware or software, or implemented with a combination of hardware and software. Further, a plurality of “modules” or a plurality of “parts,” except for a “module” or a “part” which needs to be implemented to a specific hardware, may be integrated to at least one module and implemented in at least one processor.

In the disclosure, the term ‘user’ may refer to a person that received service from a robot, but is not limited thereto.

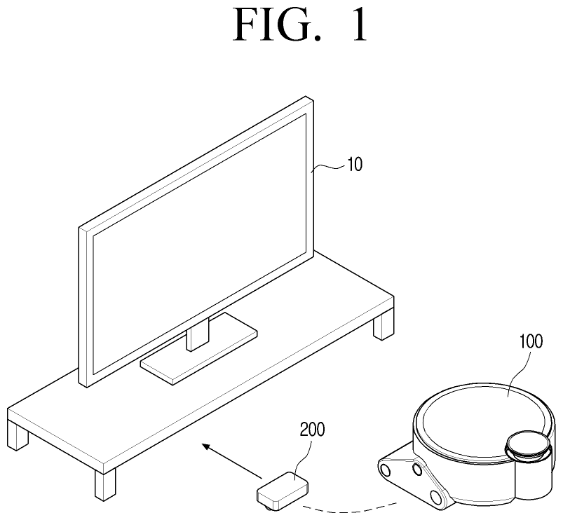

FIG. 1 is a diagram schematically illustrating a cooperative service providing operation of a robot and an external robot.

The robot 100 according to an embodiment of the disclosure may be disposed at a specific space, and provide various services to a user who lives in the space or is temporarily visiting. The robot 100 may provide services corresponding to at least one of cleaning, guiding, serving, patrolling, or emergency situation response, but is not limited thereto.

In addition, in the specific space, at least one external robot 200 may be disposed in addition to the robot 100, and the robot 100 and the at least one external robot 200 may provide services to the user through inter-cooperation. Here, providing services through cooperation may refer to the robot 100 and the at least one external robot 200 providing services associated with one another due to the robot 100 and the at least one external robot 200 being integrated and controlled integrally based on task information associated with one another.

The at least one external robot 200 may be a robot with a different specification from the robot 100. The at least one external robot 200 may have a size smaller than the robot 100, and may include a coupling part necessary for being accommodated in the robot 100. The at least one external robot 200 may be usually in standby accommodated in a storage space provided in the robot 100 and provide a service by being output from the storage space of the robot 100 when work by the at least one external robot 200 is necessary.

In addition, the at least one external robot 200 may provide a service by being controlled by the robot 100. The at least one external robot 200 may obtain task information and moving path information based on a control signal received from the robot 100, and provide a service based on the obtained task information and moving path information.

The robot according to an example may travel a space and obtain map data for the corresponding space and task information corresponding to a service to be performed by the robot 100, and determine whether work by the at least one external robot 200 is necessary based on the obtained map data and task information. For example, the robot 100 may identify that work by the external robot 200 having a size smaller than the robot 100 is necessary to clean an area in which an obstacle 10 is positioned while the robot 100 is travelling the space to provide a cleaning service.

In this case, the robot 100 may obtain task information associated with a task to be allocated to the external robot 200, and obtain moving path information associated with a path to which the external robot 200 is to move to perform the task. In addition, the robot 100 may transmit a control signal for controlling the external robot 200 to the external robot 200 based on the obtained task information and moving path information.

If an error in communication occurs between the robot 100 and the external robot 200 in a process of the external robot 200 providing a service, the robot 100 may identify a target position to which the robot 100 is to move based on an identified pose of the external robot 200 and map data of the area in which the obstacle 10 is positioned, and restore communication with the external robot 200 by moving to the identified target position.

In addition, if the external robot 200 output from the robot 100 has completed the work, the external robot 200 may return to the storage space of the robot 100 from the area in which the obstacle 10 is positioned by receiving control of the robot 100.

Various embodiments of overcoming the communication error by moving to a determined target position determined based on the pose of the external robot and the stored map data when the communication error between the robot and the external robot occurs will be described in greater detail below.

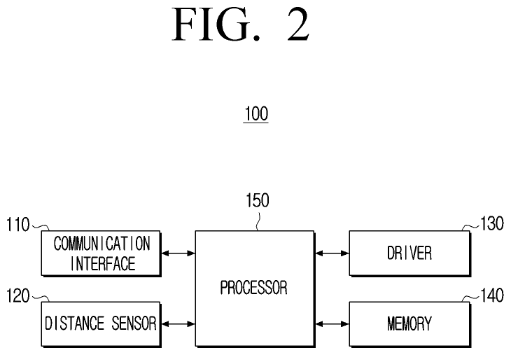

FIG. 2 is a block diagram illustrating a configuration of a robot according to an embodiment of the disclosure.

Referring to FIG. 2, the robot 100 according to an embodiment of the disclosure may include a communication interface 110, a distance sensor 120, a driver 130, a memory 140, and a processor 150.

The communication interface 110 may input and output data of various types. For example, the communication interface 110 may transmit and receive data of various types with an external device (e.g., source device), an external storage medium (e.g., a USB memory), or an external server (e.g., WEBHARD) through communication methods such as, for example, and without limitation, an AP based Wi-Fi (e.g., Wi-Fi®, wireless LAN network), Bluetooth®, ZigBee®, a wired/wireless local area network (LAN), a wide area network (WAN), Ethernet®, IEEE 1394, a high-definition multimedia interface (HDMI), a universal serial bus (USB), a mobile high-definition link (MHL), Audio Engineering Society/European Broadcasting Union (AES/EBU), Optical, Coaxial, or the like.

The distance sensor 120 may obtain distance data. The distance sensor 120 may measure distance between a position of the robot 100 and a position of the at least one external robot, and obtain distance data based on the measurement result. The distance sensor 120 according to an example may include at least one from among an infrared sensor, an ultra wide band (UWB) sensor, a light detection and ranging (LiDAR) sensor, or a 3-dimensional (3D) camera, but is not limited thereto.

The driver 130 may be a device which can control a travel of the robot 100. The driver 130 may adjust a traveling direction and traveling speed according to control by the processor 150, and the driver 130 according to an example may include a device that can control a travel of the robot 100. The driver 130 may adjust a travel direction and a travel speed according to control of the processor 150, and the driver 130 according to an example may include a power generating device (e.g., a gasoline engine, a diesel engine, a liquefied petroleum gas (LPG) engine, an electric motor, and the like according to a fuel (or an energy source) used) that generates power for the robot 100 to travel, a steering device (e.g., manual steering, hydraulics steering, electronic control power steering (EPS), etc.) for adjusting the travel direction, a travel device (e.g., a wheel, a propeller, etc.) that travels the robot 100 according to power, and the like. Here, the driver 130 may be modified and implemented according to a travelling type (e.g., a wheel type, a walking type, a flying type, etc.) of the robot 100.

The memory 140 may store data necessary for the one or more embodiments of the disclosure. The memory 140 may be implemented in the form of a memory embedded in the robot 100 according to a data storage use, or in the form of a memory attachable to or detachable from the robot 100. For example, the data for the driving of the robot 100 may be stored in a memory embedded to the robot 100, and data for an expansion function of the robot 100 may be stored in a memory attachable to or detachable from the robot 100. The memory embedded in the robot 100 may be implemented as at least one from among a volatile memory (e.g., a dynamic random access memory (DRAM), a static RAM (SRAM), or a synchronous dynamic RAM (SDRAM)), or a non-volatile memory (e.g., one time programmable read only memory (OTPROM), programmable ROM (PROM), erasable and programmable ROM (EPROM), electrically erasable and programmable ROM (EEPROM), mask ROM, flash ROM, a flash memory (e.g., NAND flash or NOR flash), a hard disk drive (HDD) or a solid state drive (SSD)). In addition, a memory attachable to or detachable from the robot 100 may be implemented in a form such as, for example, and without limitation, a memory card (e.g., a compact flash (CF), a secure digital (SD), a micro secure digital (micro-SD), a mini secure digital (mini-SD), an extreme digital (xD), a multi-media card (MMC), etc.), an external memory (e.g., USB memory) connectable to a USB port, or the like.

The memory 140 according to an example may store map data corresponding to the space in which the robot 100 travels. The processor 150 may receive map data from an external server and store in the memory 140, or generate map data based on distance data obtained from the distance sensor 120 and store the same in the memory 140.

The processor 150 may control the overall operation of the robot 100. The processor 150 may control the overall operation of the robot 100 by being coupled with each configuration of the robot 100. For example, the processor 150 may control an operation of the robot 100 by being coupled with the communication interface 110, the distance sensor 120, the driver 130, and the memory 140.

The processor 150 according to an embodiment may be designated to various names such as, for example, and without limitation, a digital signal processor (DSP), a microprocessor, a central processing unit (CPU), a micro controller unit (MCU), a micro processing unit (MPU), a neural processing unit (NPU), a controller, an application processor (AP) and the like, but will be described as the processor 150 in the disclosure.

The processor 150 may be implemented as a system on chip (SoC) or a large scale integration (LSI), or may be implemented in a form of a field programmable gate array (FPGA). In addition, the processor 150 may include a volatile memory such as a SRAM.

According to an embodiment of the disclosure, the processor 150 may control the distance sensor 120 to output a sensing signal for sensing the distance with the external robot. In addition, the processor 150 may obtain position information of the external robot based on time at which at least one echo signal is received from the external robot.

In addition, the processor 150 may more accurately identify the position of the external robot based on a time at which a sensing signal obtained by the LiDAR sensor and at least one echo signal is received from the external robot.

The echo signal may refer to a signal transmitted to the robot 100 based on the external robot receiving the sensing signal, and the robot 100 may receive the echo signal through the distance sensor 120. The processor 150 may identify the distance between the robot 100 and the external robot according to at least one from among a time of flight (TOF) method or a time of arrival (TOA) method based on a time-point at which the sensing signal is output and a time-point at which the echo signal is received, and obtain position information of the external robot based on the identified distance.

The processor 150 may change the position of the robot 100 by controlling the driver 130 based on the obtained position information. For example, the processor 150 may control the driver 130 for the robot 100 to move to a position close with an identified position of the external robot based on the obtained position information and map data of the space.

In addition, the processor 150 may control an operation state of the external robot based on the obtained position information. For example, the processor 150 may control the communication interface 110 to obtain task information corresponding to the service to be performed by the external robot, and to transmit a control signal for controlling an operation state of the external robot to the external robot based on the task information and the map data of the space.

In addition, the processor 150 may identify a pose of the external robot based on a type of at least one echo signal received from the external robot if an error in communication with the external robot through the communication interface 110 is identified as having occurred. The pose may include position information of the external robot and information on a direction to which the external robot is facing, but is not limited thereto.

For example, the external robot may include a plurality of sensors disposed at different positions and output echo signals of different types, and a plurality of echo signals received from the external robot may be signals output from the respective sensors that output echo signals of different types. The processor 150 may identify the positions of the respective sensors that output the plurality of echo signals from among the plurality of sensors disposed in the external robot based on the types of the plurality of echo signals received from the external robot if an error in communication with the external robot through the communication interface 110 is identified as having occurred.

The processor 150 may identify the position of the external robot by separately calculating the distance between the respective sensors of the external robot corresponding to the received plurality of echo signals and the distance sensor 120 that received the corresponding signal, and identify the pose of the external robot based on the identified positions of the respective sensors.

If there is no problem in receiving the echo signal through the distance sensor 120 even if an error in communication through the communication interface 110 has occurred, the processor 150 may continuously update the pose of the external robot based on the echo signal received after the occurrence of the communication error. If an error has occurred in not only communication through the communication interface 110 but also in receiving the echo signal through the distance sensor 120, the processor 150 may identify the pose of the external robot based on the last received echo data, and determine that the external robot is maintaining the last identified pose.

The processor 150 may identify the target position for the robot 100 to move to remove the communication error based on the identified pose of the external robot and the stored map data. The target position may be a position to which a visibility to the position of the external robot is secured, and communication may be resumed as there is no obstacle present which interferes with the transmission and reception of radio waves between the robot 100 and the external robot when the robot 100 moves to the target position.

The processor 150 may consider pose information received from the external robot in identifying the target position of the robot 100. The pose information may include information on the position of the external robot obtained through a sensor provided in the external robot and direction to which the external robot is facing, and the processor 150 may receive pose information from the external robot through the communication interface 110, and the robot 100 may correct the identified pose of the external robot based on the received pose information.

For example, the processor 150 may identify the direction to which the external robot is facing based on the received pose information, and determine a corrected position obtained by applying weight values to the identified positions of the external robots, respectively, as the position of the external robot based on the position of the external robot identified by the robot 100 and the pose information, but is not limited thereto.

The processor 150 may identify the target position for the robot 100 to move based on the corrected pose of the external robot and information on obstacles on the stored map data. In addition, the processor 150 may control the driver 130 for the robot 100 to move to the identified target position. If communication is resumed due to the communication error between the robot 100 which moved to the target position and the external robot being removed, the robot 100 may carry on providing service by continuing to control the external robot.

According to another example, the processor 150 may obtain obstacle information based on a sensing signal obtained by the LiDAR sensor, and change the position of the communication interface 110 based on the obtained obstacle information and position information of the external robot. For example, the processor 150 may obtain information on a Z-axis in which the obstacle is positioned, and remove the communication error between the robot 100 and the external robot by adjusting a height of the communication interface 110 such that the communication interface 110 is positioned within a Z-axis range in which the obstacle is not positioned.

The processor 150 may identify the pose of the external robot based on a type of at least one echo signal received from the external robot while communicating with the external robot through the communication interface 110, and transmit a control signal for changing the pose of the external robot based on the identified pose of the external robot and the stored map data to the external robot through the communication interface 110.

The processor 150 may control the communication interface 110 to transmit the control signal for changing the pose of the external robot to the external robot if an error occurrence in communication through the communication interface 110 is predicted based on the identified pose of the external robot and the stored map data. The processor 150 may identify a likelihood of error occurrence in communication through the communication interface 110 based on information of an obstacle disposed in an area corresponding to the position of the external robot on the stored map data, the identified pose of the external robot, and the moving path of the external robot.

For example, the processor 150 may identify, based on an error in communication being identified as likely to occur due to an obstacle which interferes in the transmission and reception of radio waves between the robot 100 and the external robot within a threshold time when the external robot continues to travel like previously based on position information of the external robot and information on the direction to which the external robot is facing, an area on the map data with a likelihood of an error in communication occurring due to the obstacle, and control the communication interface 110 to transmit a control signal for the external robot to travel on a remaining area other than the corresponding area to the external robot.

That is, the processor 150 may prevent the communication error from occurring by changing or adjusting the moving path of the external robot by predicting in advance that an error in communication with the external robot through the communication interface 110 is to occur.

The robot 100 may further include a storage space in which the external robot is accommodated. The processor 150 may control for the external robot to be output from the storage space if the work by the external robot is identified as necessary, plan a moving path of the external robot based on the pose of the external robot if the work by the external robot is identified as completed, and control an operation state of the external robot for the external robot to be accommodated in the storage space based on the planned moving path.

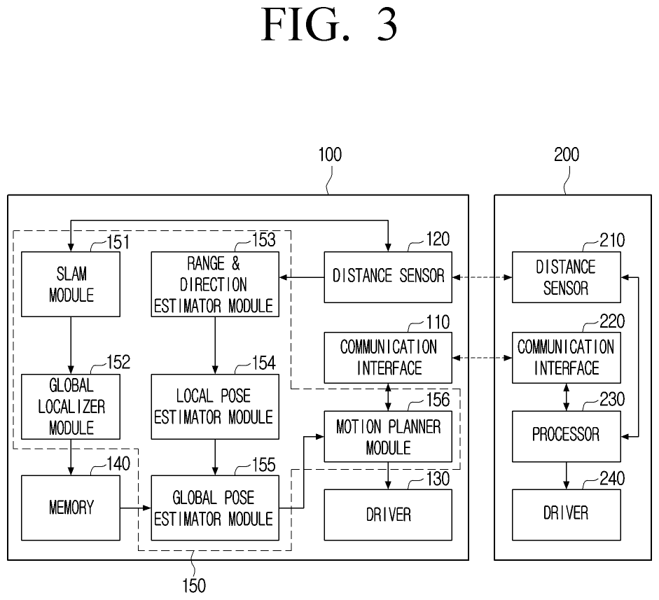

FIG. 3 is a block diagram illustrating a functional configuration of a robot according to an embodiment of the disclosure.

Referring to FIG. 3, the processor may include a SLAM module 151, a global localizer module 152, a range & direction estimator module 153, a local pose estimator module 154, a global pose estimator module 155, and a motion planner module 156.

The SLAM module 151 may obtain information on an object included in a space through a simultaneous localization and mapping method, that is, simultaneous localization and mapping (SLAM), and generate map data based on the obtained information. The object may include not only a wall, a pillar, and a fixed obstacle that form a space, but also a dynamic object that continuously changes in its position.

The SLAM module 151 according to an example may obtain a distance between the robot 100 and an object included in a space through the distance sensor 120, and generate map data of the space based on the obtained distance data. In addition, the SLAM module 151 may update map data of the space by newly obtaining distance data through the distance sensor 120 if a pre-set period arrives or if a pre-set event occurs.

The global localizer module 152 may map the position of the robot 100 on the generated map data. For example, the global localizer module 152 may obtain map data mapped with the position of the robot 100 based on map data generated by the SLAM module 151 and position information of the robot 100. In addition, the global localizer module 152 may continuously update the position of the robot 100 mapped on the map data based on the position of the robot 100 which changes according to the robot 100 moving.

The range & direction estimator module 153 may obtain information on a distance and direction reaching the external robot 200 based on the robot 100. If a distance sensor 210 of the external robot 200 includes a plurality of sensors that output echo signals of different types by being disposed at different positions of the external robot 200, the range & direction estimator module 153 according to an example may separately calculate the distance and direction between the respective sensors of the external robot 200 corresponding to the plurality of echo signals received through the distance sensor 120 and the distance sensor 120 which received the corresponding signal.

The local pose estimator module 154 may identify the pose of the external robot 200 based on distance and direction information obtained through the range & direction estimator module 153. If the external robot 200 includes a plurality of sensors, the local pose estimator module 154 according to an example may identify the pose of the external robot 200 based on the position and direction of the respective sensors obtained through the range & direction estimator module 153 if an error in communication with the external robot 200 through the communication interface 110 is identified as having occurred.

The global pose estimator module 155 may map the position and the facing direction of the external robot 200 on the whole map data based on map data mapped with the identified pose of the external robot 200 through the local pose estimator module 154 and the position of the robot 100 stored in the memory 140. In other words, if the local pose estimator module 154 obtains information on a positional relationship between the robot 100 and the external robot 200 positioned within a threshold range from the robot 100, the global pose estimator module 155 may obtain final map data mapped with information on the positions of the robot 100 and the external robot 200 and directions to which the robot 100 and the external robot 200 are facing with respect to map data obtained through the global localizer module 152 based on information obtained through the local pose estimator module 154, obstacle information included in the space, and the like.

The motion planner module 156 may obtain task information to allocate to the external robot 200 if work by the external robot 200 is identified as necessary. In addition, a path for the external robot 200 to move and associated moving path information may be obtained based on the final map data obtained through the global pose estimator module 155 and the task information to allocate to the external robot 200. The motion planner module 156 may control the communication interface 110 to transmit a control signal for driving the external robot 200 to the external robot 200 based on the obtained moving path information.

For example, the motion planner module 156 may output the external robot 200 from the storage space in which the external robot 200 is accommodated, and guide a provision of service through the external robot 200 while continuously monitoring the pose of the output external robot 200. In addition, the motion planner module 156 may plan a return path of the external robot 200 based on the pose of the external robot 200 when the work by the external robot 200 is identified as having been completed, and transmit a control signal for the external robot 200 to be accommodated in the storage space to the external robot 200 through the communication interface 110 based on the planned return path.

If an error in communication with the external robot 200 through the communication interface 110 is identified as having occurred, the motion planner module 156 may identify a target position for the robot to move to resume communication based on the final map data, and control the driver 130 for the robot 100 to move to the identified target position. The motion planner module 156 according to an example may correct the final map data taking into consideration pose information received from the external robot 200 through the communication interface 110, and identify the target position based on the corrected final map data.

In addition, the motion planner module 156 may calculate a likelihood of error occurrence in communication through the communication interface 110 based on information on obstacles disposed in an area corresponding to the position of the external robot 200 based on the final map data, the pose of the external robot 200, and the moving path of the external robot 200, and control the communication interface 110 to transmit a control signal for changing the pose of the external robot 200 to the external robot 200 if the likelihood of error occurrence is identified as greater than or equal to a threshold value.

According to another example, the motion planner module 156 may remove the communication error between the robot 100 and the external robot 200 by adjusting the height of the interface 110 based on obstacle information obtained through the distance sensor 120 and position information of the external robot 200 if the likelihood of error occurrence in communication through the communication interface 110 is identified as greater than or equal to the threshold value.

The external robot 200 according to an embodiment of the disclosure may include a distance sensor 210, a communication interface 220, a processor 230, and a driver 240. The distance sensor 210 may include a plurality of sensors which output echo signals of different types by being disposed at different positions on the external robot 200. The communication interface 220 may transmit and receive data of various types from the relationship with the communication interface 110 of the robot 100 according to a short range communication method which includes Bluetooth® communication.

The processor 230 may control the overall operation of the external robot 200 by being coupled with each configuration of the external robot 200. For example, the processor 230 may output, based on a sensing signal for sensing the distance between the robot 100 and the external robot 200 being received from the robot 100, a plurality of echo signals having different types through the plurality of sensors included in the distance sensor 210.

In addition, the processor 230 may control, based on the control signal for driving the external robot 200 being received through the communication interface 220, the driver 240 for the external robot 200 to operate based on the received control signal. For example, the processor 230 may change the pose of the external robot 200 based on the received control signal, but is not limited thereto.

In addition, the processor 230 may obtain pose information including information on the position of the external robot 200 and the direction to which the external robot 200 is facing and control the communication interface 220 to transmit the obtained pose information to the robot 100.

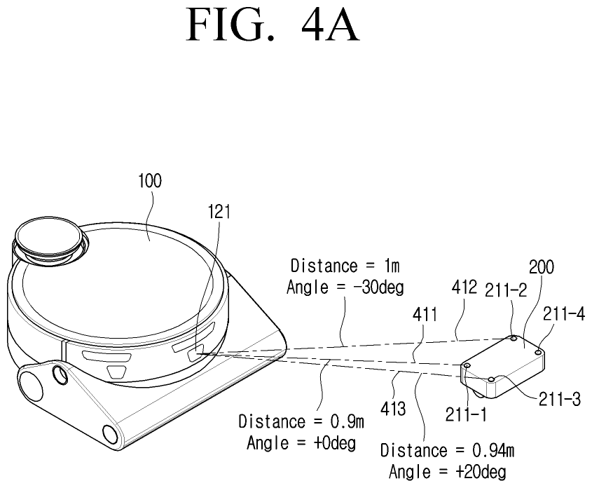

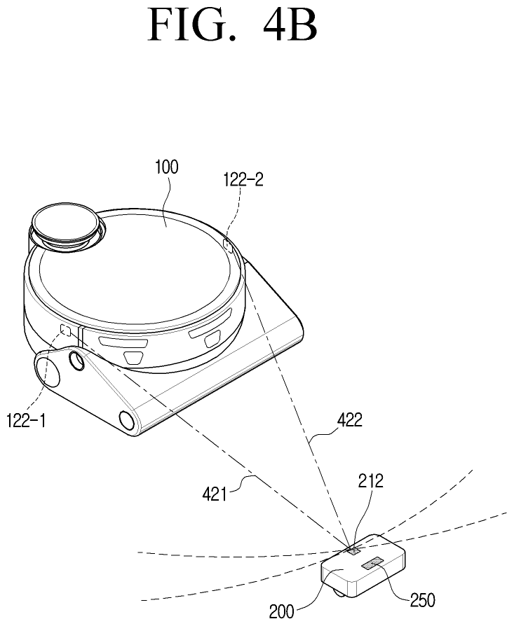

FIG. 4A and FIG. 4B are diagrams illustrating an operation by a robot identifying a pose of an external robot according to an embodiment of the disclosure.

Referring to FIG. 4A, the distance sensor 120 provided in the robot 100 may include an infrared sensor 121, and the external robot 200 may include a plurality of sensors 211-1 to 211-4 which output echo signals of different types by being disposed at different positions. Here, information on a disposition relationship of the plurality of sensors 211-1 to 211-4 positioned in the external robot 200 may be pre-stored in the memory 140.

The processor 150 may control the infrared sensor 121 to output a sensing signal for sensing the distance with the external robot 200. The external robot 200 which received the sensing signal output from the infrared sensor 121 through the plurality of sensors 211-1 to 211-4 may output a plurality of echo signals having different types through the respective sensors 211-1 to 211-4. Referring to FIG. 4A, because only first to third sensors 211-1 to 211-3 from among the plurality of sensors 211-1 to 211-4 receive the sensing signal, the external robot 200 may output echo signals of three types corresponding to the first to third types, respectively.

The robot 100 may receive echo signals of three types corresponding to the first to third types through the infrared sensor 121, and identify the positions of the first to third sensors 211-1 to 211-3 corresponding to the respective echo signals received based on time at which the plurality of echo signals are received.

The robot 100 may respectively identify that a distance between the infrared sensor 121 and a first sensor 211-1 is 0.9 m and an angle formed thereto is 0 degrees (411), a distance between the infrared sensor 121 and a second sensor 211-2 is 1 m and an angle formed thereto is −30 degrees (412), and a distance between the infrared sensor 121 and a third sensor 211-3 is 0.94 m and an angle formed thereto is +20 degrees (413), and identify the pose of the external robot 200 based therefrom.

In FIG. 4A the robot 100 is shown as including a single infrared sensor 121 positioned at a front surface part, but is not limited thereto, and the robot 100 may further include infrared sensors at a side surface part and a back surface part. In this case, the robot 100 may more accurately identify the pose of the external robot 200 based on a plurality of data sets obtained through a plurality of infrared sensors 121 and the like.

Referring to FIG. 4B, the distance sensor 120 provided in the robot 100 may include a pair of ultra wide band (UWB) sensors 122-1 and 122-2, and the distance sensor 210 provided in the external robot 200 may include a UWB sensor 212. In this case, the pair of UWB sensors 122-1 and 122-2 provided in the robot 100 may operate as a UWB anchor, and the UWB sensor 212 provided in the external robot 200 may operate as a UWB tag, but are not limited thereto.

According to an example, the sensor 212 provided in the external robot 200 operating as a UWB tag may continuously output radio waves. The processor 150 may control the pair of UWB sensors 122-1 and 122-2 to output a sensing signal for sensing the distance with the external robot 200 based on receiving the radio waves continuously being output from the sensor 212 provided in the external robot 200. The external robot 200 that received the sensing signal output from the pair of UWB sensors 122-1 and 122-2 through the UWB sensor 212 may output an echo signal through the UWB sensor 212.

The robot 100 may receive the echo signal through the pair of UWB sensors 122-1 and 122-2, and obtain a pair of distance data sets corresponding to each of the pair of UWB sensors 122-1 and 122-2 based on time at which the echo signal is received. In addition, the robot 100 may identify that the UWB sensor 212 included in the external robot 200 is positioned at a point at which a virtual circle corresponding to distance data 421 obtained through a first UWB sensor 122-1 and a virtual circle corresponding to distance data 422 obtained through a second UWB sensor 122-2 intersects, and identify the pose of the external robot 200 based on the identified position of the UWB sensor 212.

In FIG. 4B, the robot 100 is shown as including the pair of UWB sensors 122-1 and 122-2, and the external robot 200 is shown as including the single UWB sensor 212, but the robot 100 and the external robot 200 may include additional UWB sensors, and through the above, the robot 100 may more accurately identify the pose of the external robot 200.

In addition, the external robot 200 according to an example may further include an inertia measurement device 250. The inertia measurement device 250 may include a sensor such as an accelerometer, a tachometer, and a magnetometer, and the external robot 200 may obtain information on a position change value of the external robot 200 corresponding to a traveling history of the external robot 200 and a rotation angle of the external robot 200 based on sensing data obtained through the inertia measurement device 250.

In addition, the processor 230 may obtain pose information of the external robot 200 based on the obtained information, and transmit the obtained pose information to the robot 100 through the communication interface 220. The robot 100 may correct the pose of the external robot 200 identified by the robot 100 based on the pose information received from the external robot 200.

That is, if the external robot 200 includes the inertia measurement device 250, the robot 100 may be able to more accurately identify the pose of the external robot 200, and if an error in communication with the external robot 200 occurs thereafter, more accurately identify the target position for the robot 100 to move to remove the communication error.

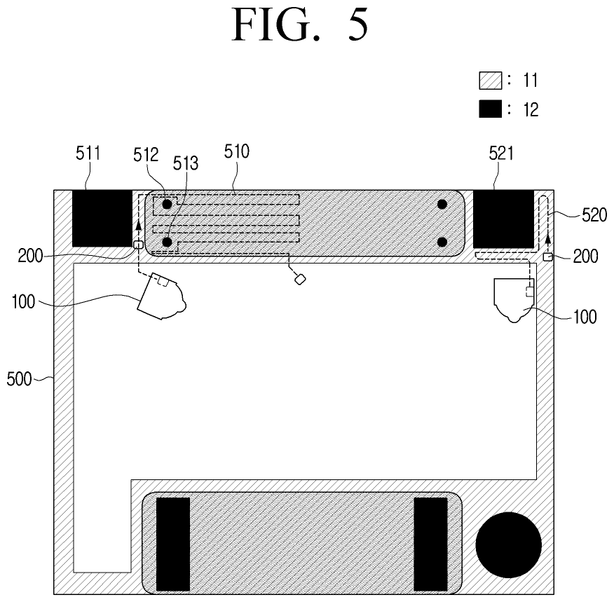

FIG. 5 is a diagram illustrating an operation by a robot controlling an external robot based on map data according to an embodiment of the disclosure.

Referring to FIG. 5, the robot 100 may provide a cleaning service while traveling a space corresponding to map data 500. Here, in the map data 500, information on an area 11 through which the robot 100 is not able to travel and information on an obstacle area 12 through which both the robot 100 and the external robot 200 are not able to travel may be included.

The robot 100 according to an example may accommodate at least one external robot 200 in the storage space, output the external robot 200 if cleaning work by the external robot 200 is identified as necessary, and guide for the external robot 200 to provide a service while traveling within an area 11 through which the robot 100 is not able to travel.

For example, the robot 100 may control an operation state of the external robot 200 based on information on obstacles disposed in the area corresponding to the position of the external robot 200 on the map data 500, the identified pose information of the external robot 200, and the moving path of the external robot 200. The robot 100 may obtain a moving path 510 for cleaning a floor surface underneath a furniture or a moving path 520 for cleaning a narrow space between a furniture and a wall surface through the external robot 200, and control the operation state of the external robot 200 based on task information corresponding to the obtained moving path 510 or 520 and the moving path information.

If the robot 100 controls the external robot 200 based on the moving path 510 for cleaning the floor surface underneath the furniture, the robot 100 may control the external robot 200 based on information on obstacles 511, 512, and 513 adjacent with the identified moving path 510 and the identified pose and moving path 510 of the external robot 200. In this case, the robot 100 may continuously monitor the pose of the external robot 200 and continuously update the designated moving path 510 for the external robot 200 to not collide with the obstacles 511, 512, and 513. In addition, the robot 100 may change the pose of the external robot 200 for the external robot 200 to travel along the updated moving path 510.

If the robot 100 controls the external robot 200 based on the moving path 520 for cleaning the narrow space between the furniture and the wall surface, the robot 100 may control the external robot 200 based on information on an obstacle 521 adjacent with the identified moving path 520 and the identified pose and moving path 520 of the external robot 200. In this case, the robot 100 may continuously update the designated moving path 520 for the external robot 200 to perform a cleaning task in a state spaced apart by a threshold distance from a surface of the obstacle 521.

In addition, the robot 100 may calculate a likelihood of error occurrence in communication between the robot 100 and the external robot 200 based on the information on obstacles disposed in the area corresponding to the position of the external robot 200 on the map data 500, the identified pose information of the external robot 200, and the moving path of the external robot 200. The robot 100 may transmit a control signal for changing the pose of the external robot 200 to the external robot 200 based on the calculated likelihood of error occurrence being identified as greater than or equal to the threshold value.

In this case, the robot 100 may identify the pose of the external robot 200 at a reference view point, and based on the external robot traveling along a pre-stored moving path 510 or 520 based on the identified pose, control to change the pose of the external robot 200 for the external robot 200 to travel long a corrected moving path and not the pre-stored moving path 510 or 520 if the external robot 200 is predicted as having collided with an obstacle 511, 512, 513, or 521 disposed at an area in which the external robot 200 is positioned.

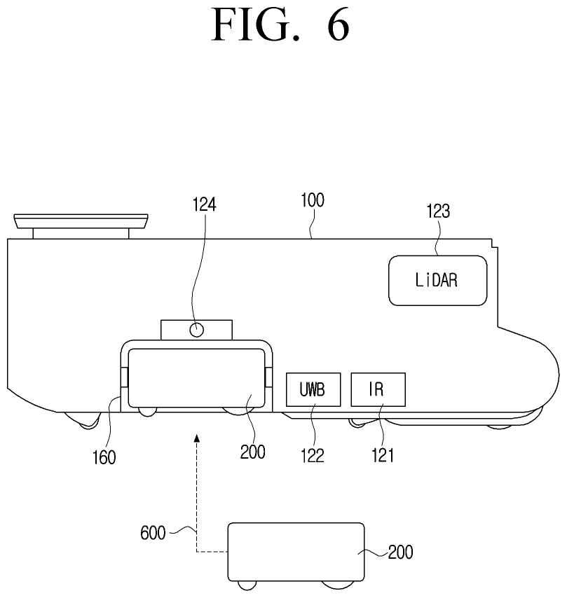

FIG. 6 is a diagram illustrating an operation by a robot accommodating an external robot according to an embodiment of the disclosure.

Referring to FIG. 6, the robot 100 may further include a storage space 160, and the distance sensor 120 provided in the robot 100 may include an infrared sensor 121, a UWB sensor 122, a LIDAR sensor 123, and a 3D camera 124. The robot 100 may plan, if work by the external robot 200 is identified as completed, a return path 600 through which the external robot 200 moves to be accommodated in the storage space 160 based on the pose of the external robot 200. For example, the processor 150 may identify the pose of the external robot 200 based on a sensing signal obtained through the LIDAR sensor 123 and at least one echo signal received from the external robot 200 through the infrared sensor 121 or the UWB sensor 122, and plan the return path 600 based on the identified pose of the external robot 200.

If the external robot 200 moves through the return path 600, the robot 100 may continuously update the pose of the external robot 200 based on data obtained through the distance sensor 120. In addition, the robot 100 may continuously update the return path 600 of the external robot 200 based on a depth image obtained through the 3D camera 124 and the updated pose of the external robot 200.

Accordingly, the robot 100 or the external robot 200 may be prevented from being damaged in an accommodating process of the external robot 200 by the robot 100 continuously updating an optimal path 600 for the external robot 200 to be accurately accommodated in the storage space 160 in a return scenario of the external robot 200.

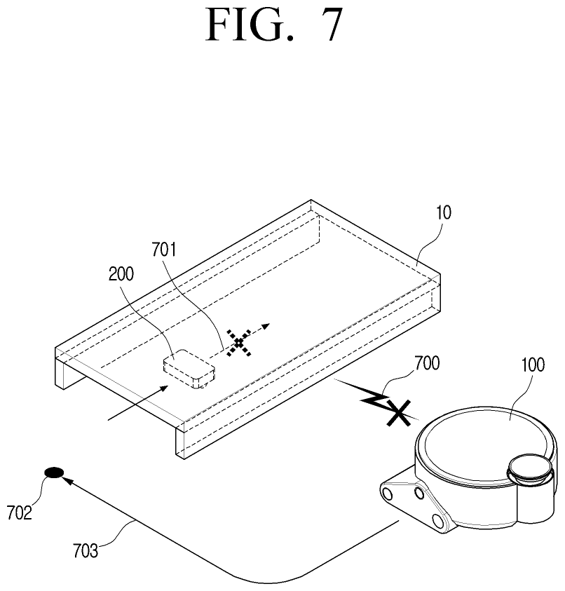

FIG. 7 is a diagram illustrating an error removal operation of a robot according to an embodiment of the disclosure.

Referring to FIG. 7, an error in communication between the robot 100 and the external robot 200 may occur 700 while the external robot 200 is providing a cleaning service traveling the floor surface underneath a furniture 10. In this case, the external robot 200 may stop at a present position without traveling any further when an error in communication is identified as having occurred 700.

The processor 150 may identify, based on an error in communication with the external robot 200 through the communication interface 110 being identified as having occurred 700, a target position 702 from which visibility to the position of the external robot 200 is secured to resume communication based on the pose of the external robot 200 and map data corresponding to the area including the floor surface underneath the furniture 10. In addition, the processor 150 may control the driver 130 for the robot 100 to travel 703 to the identified target position.

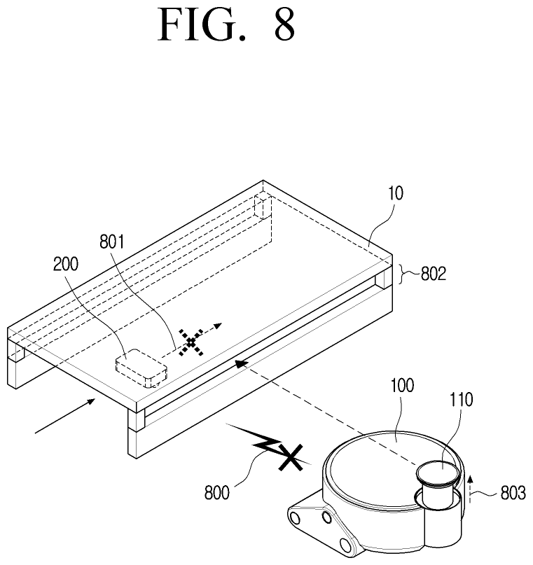

FIG. 8 is a diagram illustrating an error removal operation of a robot according to another embodiment of the disclosure.

Referring to FIG. 8, an error in communication between the robot 100 and the external robot 200 may occur 800 while the external robot 200 is providing a cleaning service traveling the floor surface of the furniture 10 of which a portion area from among a side surface is opened. In this case, the external robot 200 may stop at a present position without traveling any further when an error in communication is identified as having occurred 800.

The processor 150 may identify, based on an error in communication with the external robot 200 through the communication interface 110 being identified as having occurred 800, a target height range 802 from which visibility to the position of the external robot 200 is secured to resume communication based on the pose of the external robot 200 and information on obstacles included on the map data corresponding to the area which includes the floor surface underneath the furniture 10.

For example, the processor 150 may remove the communication error between the robot 100 and the external robot 200 by obtaining information on the Z-axis in which the obstacle 10 is positioned, and adjusting 803 the height of the communication interface 110 by controlling the driver 130 for the communication interface 110 to be positioned within a Z-axis range 802 in which the obstacle 10 is not positioned.

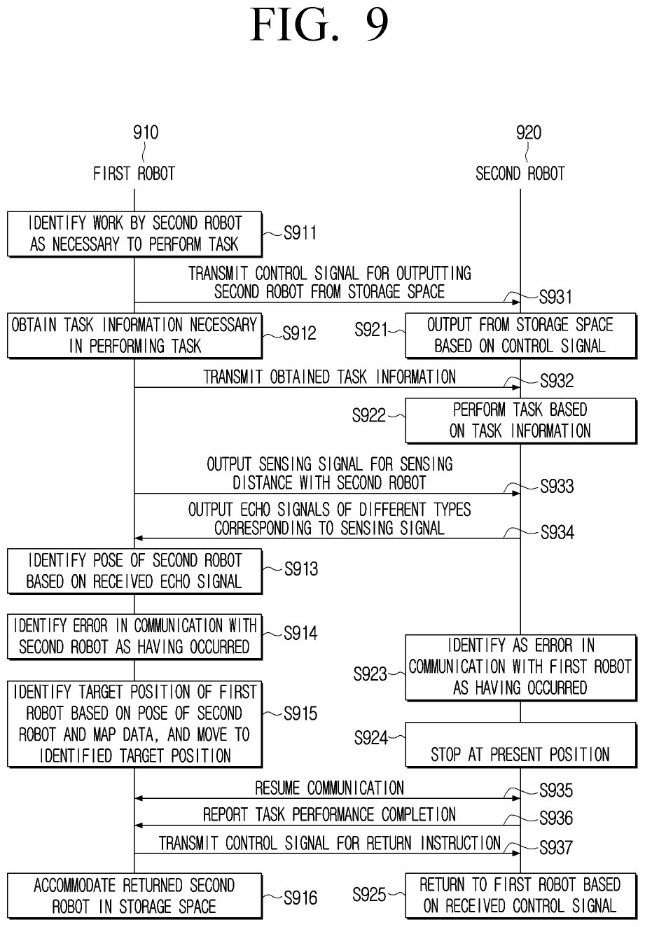

FIG. 9 is a sequence diagram illustrating a service providing process through a robot system according to an embodiment of the disclosure.

The robot system which includes a first robot 910 and a second robot 920 which is accommodated in a storage space of the first robot 910 according to an embodiment of the disclosure may provide a service through cooperation by the first robot 910 and the second robot 920. In addition, the robot system may remove the communication error through an active operation of the first robot 910 and the second robot 920 if an error in communication between the first robot 910 and the second robot 920 occurs.

First, the first robot 910 may identify that work by the second robot 920 is necessary to perform a task (S911). In this case, the first robot 910 may transmit a control signal for outputting the second robot 920 from the storage space to the second robot 920 (S931), and the second robot 920 which received the control signal may be output from the storage space based on the control signal (S921).

Then, the first robot 910 may obtain task information necessary in performing a task of the second robot 920 (S912), and transmit the obtained task information to the second robot 920 (S932). In this case, the first robot 910 may transmit moving path information necessary in performing the task to the second robot 920 together with the task information.

The second robot 920 which received the task information (and moving path information) from the first robot 910 may perform a task based on the received task information (S922). The first robot 910 may continuously monitor the pose of the second robot 920 in the process of the second robot 920 performing a task.

The first robot 910 may output a sensing signal for sensing a distance with the second robot 920 (S933), and the second robot 920 which received the sensing signal may output echo signals of different types corresponding to the sensing signal (S934). The first robot 910 may identify the pose of the second robot based on the received echo signals (S913).

The second robot 920 may identify that an error in communication with the first robot 910 has occurred while performing a task (S923). In this case, the second robot 920 may stop at a present position without traveling any further (S924).

The first robot 910 may identify, in the process of the second robot 920 performing a task, that an error in communication with the second robot 920 has occurred (S914). In this case, the first robot 910 may identify the target position of the first robot 910 based on the pose of the second robot 920 and the map data, and move to the identified target position (S915).

If communication between the first robot 910 and the second robot 920 is resumed as the first robot 910 moves to the target position (S935), the second robot 920 may transmit a signal instructing that performing of the allocated task has been completed to the first robot 910 (S936). The first robot 910 which received report of task performance completion from the second robot 920 may transmit a control signal instructing the return of the second robot 920 to the second robot 920 for the second robot 920 to be accommodated in the storage space (S937).

When the second robot 920 returns to the first robot based on the received control signal (S925), the first robot 910 may accommodate the returned second robot 920 in the storage space (S916) and end the provision of service.

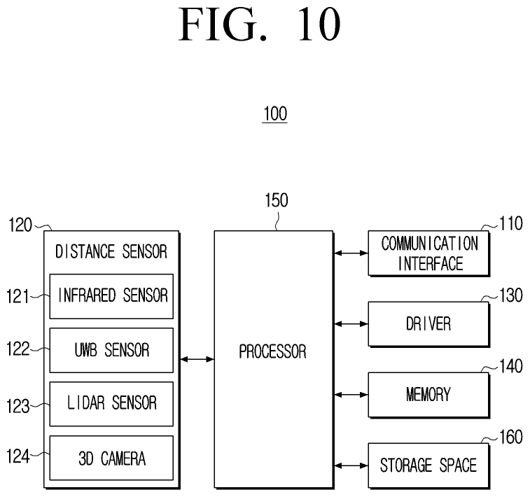

FIG. 10 is a block diagram illustrating in detail a configuration of a robot according to an embodiment of the disclosure.

Referring to FIG. 10, the robot 100 may include the communication interface 110, the infrared sensor 121, the UWB sensor 122, the LiDAR sensor 123, the 3D camera 124, the driver 130, the memory 140, the processor 150, and the storage space 160. Detailed descriptions of configurations that overlap with the configurations shown in FIG. 2 from among the configurations shown in FIG. 10 will be omitted.

The infrared sensor 121 may include a transmitter which emits infrared rays and a receiver which senses infrared rays. The processor 150 may obtain distance data between the infrared sensor 121 and a sensor provided in the external robot based on time between a time-point at which the infrared rays are emitted through the transmitter and a time-point at which an echo of signal infrared signal is received through the receiver and time delay required until the output of the echo signal of the external robot and velocity of light.

The UWB sensor 122 may be a type of a radar sensor which uses electromagnetic waves having an ultra-wide band frequency. According to an example, the processor 150 may output a sensing signal for sensing the distance with the external robot through the UWB sensor 122 acting as the UWB anchor based on receiving radio waves which are continuously output from the external robot, and obtain, by receiving an echo signal corresponding to the sensing signal from the external robot through the UWB sensor 122, distance data between the UWB sensor 122 and the sensor (UWB tag) provided in the external robot based on time between an output time-point of the sensing signal and a receiving time-point of the echo signal and delay time required until the output of the echo signal of the external robot and velocity of light.

The LiDAR sensor 123 may be a type of sensor which uses a laser. The LiDAR sensor 123 may include a mechanical stricture capable of rotating 360 degrees, and the processor 150 may control for the LiDAR sensor 123 to output a laser while continuously rotating. The processor 150 may obtain distance data between the LiDAR sensor 123 and the object by sensing a laser signal output through the LiDAR sensor 123 which is reflected by a surrounding object and returned.

The 3D camera 124 may be a configuration for obtaining a depth image. The 3D camera 124 may be implemented in a form of a camera module which includes a plurality of lenses and a plurality of image sensors. According to an example, the 3D camera 124 may be a stereo camera which includes two lenses and two image sensors, but is not limited thereto. The processor 150 may identify a more accurate pose of the external robot by taking into consideration even the depth image which is obtained through the 3D camera 124 in the process of identifying the pose of the external robot.

The storage space 160 may be a configuration for accommodating the external robot. The storage space 160 may be implemented in a cavity form having a greater volume than a size of the external robot, but is not limited thereto, and the storage space 160 may be disposed at a surface of the robot 100, and implemented in a form including a fastening member by which the external robot is accommodated in the robot 100 bond with the coupling part provided in the external robot.

The processor 150 may control, based on the external robot being output due to work by the external robot being identified as necessary while the external robot is in an accommodated state, the driver 130 such that a fastening part included in the storage space 160 is to be detached from the coupling part provided in the external robot for the external robot to be separated from the robot 100. Alternatively, in a process of the external robot returning to be accommodated in the robot 100, the processor 150 may control the driver 130 such that the fastening part included in the storage space 160 is to be coupled with the coupling part provided in the external robot for the external robot to be accommodated in the robot 100.

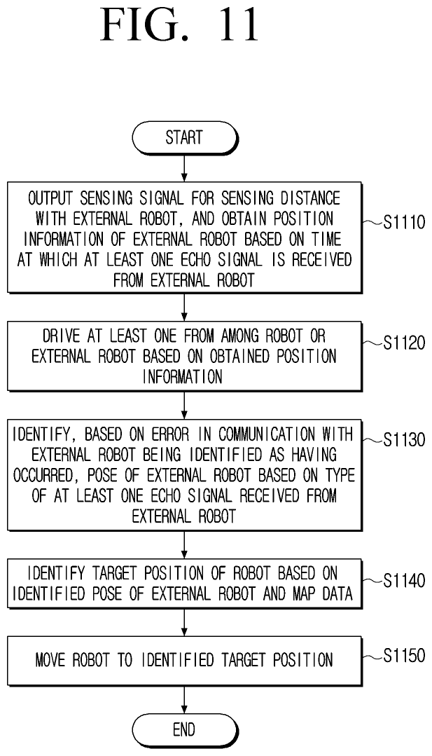

FIG. 11 is a flowchart illustrating a controlling method according to an embodiment of the disclosure.

The controlling method according to an embodiment of the disclosure may include outputting a sensing signal for sensing the distance with the external robot, and obtaining position information of the external robot based on time at which at least one echo signal is received from the external robot (S1110).

Then, at least one from among the robot or the external robot may be driven based on the obtained position information (S1120).

Then, the pose of the external robot may be identified based on the type of at least one echo signal received from the external robot when an error in communication with the external robot is identified as having occurred (S1130).

Then, the target position of the robot may be identified based on the identified pose of the external robot and the map data (S1140).

Lastly, the robot may be moved to the identified target position (S1150).

Here, the identifying the pose of the external robot (S1130) may include identifying the pose of the external robot based on the type of at least one echo signal received from the external robot while communicating with the external robot. In addition, the controlling method may further include changing the pose of the external robot based on the identified pose of the external robot and the map data.

In addition, changing the pose of the external robot if an error occurrence in communication is predicted based on the identified pose of the external robot and the map data may be further included.

In the changing the pose of the external robot, a likelihood of error occurrence in communication may be determined based on information on obstacles disposed in the area corresponding to the position of the external robot on the map data, the identified pose of the external robot, and the moving path of the external robot.

The identifying the pose of the external robot (S1130) may include identifying the positions of the respective sensors which output the plurality of echo signals from among the plurality of sensors disposed in the external robot based on the types of the plurality of echo signals received from the external robot when an error in communication with the external robot is identified as having occurred and identifying the pose of the external robot based on the identified positions of the respective sensors.

The methods according to the one or more embodiments of the disclosure described above may be implemented in application form installable in robots of the related art.

In addition, the identifying the target position of the robot (S1140) may include identifying, based on the pose information being received from the external robot, the target position of the robot based on the received pose information, the identified pose of the external robot, and the map data.

In addition, in the obtaining the position information of the external robot (S1110), the position information of the external robot may be obtained based on the sensing signal obtained by the LiDAR sensor and the time at which at least one echo signal is received from the external robot.

In addition, obtaining obstacle information based on the sensing signal obtained by the LiDAR sensor and changing the position of the communication interface provided in the robot based on the obtained obstacle information and the position information of the external robot may be further included.

In addition, outputting the external robot from the storage space in which the external robot is accommodated when work by the external robot is identified as necessary, planning a moving path of the external robot based on the pose of the external robot when work by the external robot is identified as completed, and accommodating the external robot in the storage space based on the planned moving path may be further included.

As described above, the communication error may be overcome by moving to the determined target position based on the pose of the external robot and the map data if an error in communication between the robot and the external robot occurs. Accordingly, because the error which occurred in the communication between the robot and the external robot may be actively removed and provision of service may be resumed, user convenience may be improved.

The methods according to the one or more embodiments of the disclosure described above may be implemented with only a software upgrade or a hardware upgrade of robots of the related art.

In addition, the one or more embodiments of the disclosure described above may be performed through an embedded server provided in the robot or at least one external server.

The one or more embodiments described above may be implemented in a recordable medium which is readable by computer or a device similar to computer using software, hardware, or the combination of software and hardware. In some cases, the embodiments described herein may be implemented by the processor 150 on its own. According to a software implementation, embodiments such as the procedures and functions described herein may be implemented with separate software modules. Each of the software modules may perform one or more of the functions and operations described herein.

Computer instructions for performing processing operations in the robot 100 according to the one or more embodiments of the disclosure described above may be stored in a non-transitory computer-readable medium. The computer instructions stored in this non-transitory computer-readable medium may cause a specific device to perform a processing operation of the robot 100 according to the one or more embodiments when executed by a processor of the specific device.

The non-transitory computer-readable medium may refer to a medium that stores data semi-permanently rather than storing data for a very short time, such as a register, a cache, a memory, or the like, and is readable by a device. Specific examples of the non-transitory computer-readable medium may include, for example, and without limitation, a compact disc (CD), a digital versatile disc (DVD), a hard disc, a Blu-ray disc, a USB, a memory card, a ROM, and the like.

While the disclosure has been illustrated and described with reference to example embodiments thereof, it will be understood that the specific embodiments described above are intended to be illustrative, not limiting. It will be understood by those skilled in the art that various changes in form and details may be made therein without departing from the true spirit and full scope of the disclosure, including the appended claims and their equivalents.

The above-described embodiments are merely specific examples to describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. A robot comprising:
a communication interface;
a sensor configured to obtain distance data;
a driver configured to control a movement of the robot;
a memory storing with map data corresponding to a space in which the robot travels; and
a processor configured to:
control the sensor to output a sensing signal for sensing a distance with an external robot,
obtain position information of the external robot based on a time at which at least one echo signal is received from the external robot,
control at least one of the driver or an operation state of the external robot based on the position information,
transmit a control signal for controlling the operation state of the external robot through the communication interface,
identify, based on an error occurring in communication with the external robot through the communication interface, a pose of the external robot based on a type of the at least one echo signal received from the external robot,
identify a target position of the robot based on the pose of the external robot and the stored map data, and
control the driver to move to the target position.

2. The robot of claim 1, wherein the processor is further configured to:
identify, while communicating with the external robot through the communication interface, the pose of the external robot based on the type of the at least one echo signal received from the external robot, and
transmit a control signal for changing the pose of the external robot to the external robot through the communication interface based on the pose of the external robot and the stored map data.

3. The robot of claim 1, wherein the processor is further configured to transmit, based on an error occurrence in communication through the communication interface being predicted based on the pose of the external robot and the stored map data, a control signal for changing the pose of the external robot to the external robot through the communication interface.

4. The robot of claim 3, wherein the processor is further configured to determine a likelihood of an error occurring in communication through the communication interface based on information on obstacles disposed in an area corresponding to a position of the external robot on the map data, the pose of the external robot, and a moving path of the external robot.

5. The robot of claim 1, wherein the external robot comprises a plurality of sensors configured to output echo signals of different types and disposed at different positions, and
wherein the processor is further configured to:
identify, based on an error occurring in communication with the external robot through the communication interface, positions of the plurality of sensors, which output a plurality of echo signals from among the plurality of sensors disposed in the external robot, based on types of the plurality of echo signals received from the external robot, and
identify the pose of the external robot based on the positions of the plurality of sensors.

6. The robot of claim 1, wherein the processor is further configured to identify, based on pose information being received from the external robot through the communication interface, the target position of the robot based on the pose information, the pose of the external robot, and the stored map data.

7. The robot of claim 1, wherein the sensor comprises a light detection and ranging (LiDAR) sensor, and
wherein the processor is further configured to obtain the position information of the external robot based on a sensing signal obtained by the LiDAR sensor and the time at which the at least one echo signal is received from the external robot.

8. The robot of claim 1, wherein the sensor comprises a light detection and ranging (LiDAR) sensor, and
wherein the processor is further configured to:
obtain obstacle information based on a sensing signal obtained by the LiDAR sensor, and
change a position of the communication interface based on the obstacle information and the position information of the external robot.

9. The robot of claim 1, further comprising a storage space configured to accommodate the external robot,
wherein the processor is further configured to:
control, based on work by the external robot being identified as necessary, an output of the external robot from the storage space,
plan, based on the work by the external robot being identified as completed, a moving path of the external robot based on the pose of the external robot, and
control the operation state of the external robot to accommodate the external robot in the storage space based on the moving path.

10. The robot of claim 1, wherein the communication interface is configured to communicate according to a short range communication method comprising Bluetooth communication, and
wherein the sensor comprises at least one of an infrared sensor or an ultra wide band (UWB) sensor.

11. A system comprising:
a first robot; and
a second robot which is accommodated in a storage space of the first robot,
wherein the second robot comprises a plurality of sensors configured to output echo signals of different types by being disposed at different positions, and
wherein the first robot is configured to:
transmit a control signal for outputting the second robot from the storage space to the second robot through a communication interface based on work by the second robot being identified as necessary,
transmit, based on the work by the second robot being identified as completed, a control signal for accommodating the second robot in the storage space to the second robot through the communication interface,
output a sensing signal for sensing a distance with the second robot,
identify, based on an error occurring in communication with the second robot through the communication interface, positions of the respective sensors, which output a plurality of echo signals from among the plurality of sensors disposed in the second robot, based on the types of the plurality of echo signals received from the second robot,
identify a pose of the second robot based on the positions of the plurality of sensors,
identify a target position of the first robot based on the pose of the second robot and based on map data, and
move to the target position.

12. A method of controlling a robot, the method comprising:
outputting a sensing signal for sensing a distance with an external robot, and obtaining position information of the external robot based on a time at which at least one echo signal is received from the external robot;
driving at least one of the robot or the external robot based on the position information;
identifying, based on an error in communication with the external robot, a pose of the external robot based on a type of the at least one echo signal received from the external robot;
identifying a target position of the robot based on the pose of the external robot and map data; and
moving the robot to the target position.

13. The method of claim 12, wherein the identifying the pose of the external robot comprises identifying, while communicating with the external robot, the pose of the external robot based on the type of at least one echo signal received from the external robot, and
wherein the method further comprises changing the pose of the external robot based on the pose of the external robot and the map data.

14. The method of claim 12, further comprising:
changing, based on an error occurrence in communication being predicted based on the pose of the external robot and the map data, the pose of the external robot.

15. The method of claim 14, wherein the changing the pose of the external robot comprises determining a likelihood of an error occurring in communication based on information of obstacles disposed in an area corresponding to a position of the external robot on the map data, the pose of the external robot, and a moving path of the external robot.

16. The method of claim 12, wherein the identifying the pose of the external robot comprises:
identifying, based on an error occurring in communication with the external robot through a communication interface, positions of a plurality of sensors, which output a plurality of echo signals from among the plurality of sensors disposed in the external robot, based on types of the plurality of echo signals received from the external robot, and
identifying the pose of the external robot based on the positions of the plurality of sensors.

17. The method of claim 12, wherein the identifying the target position of the first robot comprises:
identifying, based on pose information being received from the external robot through a communication interface, the target position of the robot based on the pose information, the pose of the external robot, and the stored map data.

18. The method of claim 12, wherein the obtaining position information of the external robot comprises:
obtaining the position information of the external robot based on a sensing signal obtained by a light detection and ranging (LiDAR) sensor and the time at which the at least one echo signal is received from the external robot.

19. The method of claim 12, wherein the method further comprises:
obtaining obstacle information based on a sensing signal obtained by a LiDAR sensor, and
changing a position of a communication interface based on the obstacle information and the position information of the external robot.

20. The method of claim 12, wherein the method further comprises:
controlling, based on work by the external robot being identified as necessary, an output of the external robot from a storage space,
planning, based on the work by the external robot being identified as completed, a moving path of the external robot based on the pose of the external robot, and
controlling an operation state of the external robot to accommodate the external robot in the storage space based on the moving path.
